(19) United States
(12) Patent Application Publication
(10) Pub. No.: US 2006/0196618 A1
(43) Pub. Date: Sep. 7, 2006

(54) Blind slat structure

(75) Inventor: Wen Ying Liang, Lugang Town (TW)

Correspondence Address: TROXELL LAW OFFICE PLLC;SUITE 1404, 5205 LEESBURG PIKE, FALLS CHURCH, VA, 22041, US

(73) Assignee: Ching Feng Home Fashions Co., Ltd.

(21) Appl. No.: 11/099,635

(22) Filed: Apr. 6, 2005

(30) Foreign Application Priority Data
Mar. 1, 2005 (TW) 094203115

(51) Int. Cl. E06B 3/12

(52) U.S. Cl. 160/236

(57) ABSTRACT

A blind slat structure includes a slat body made up of an upper slat piece and a matching lower slat piece that, preferably molded of plastic materials, compound materials, glass fibers, and textile materials, etc., are mutually overlapped with one superimposed on top of the other, and parallel and equally-spaced inner and outer fixing portions are symmetrically disposed at predetermined positions of both elongate edges of the overlapped upper and lower slat pieces thereon to securely combine both upper and lower slat pieces thereby and form a retaining space at each elongate edge thereof for holding a support member of plastic materials, compound materials, glass fibers, and textile materials, etc. therein. Therefore, via the fixing portions thereof, the blind slat obtained thereby can not only provide versatile stylistic change to boost the visual effect thereof, but also refrain from the problem of furry edges in production to achieve a neat and beautiful look in display thereof.

### BACKGROUND OF THE INVENTION

The present invention is related to a blind slat structure, including a slat body made up of an upper slat piece and a matching lower slat piece that, preferably molded of plastic materials, compound materials, glass fibers, and textile materials, etc., are mutually overlapped with parallel and equally spaced fixing portions symmetrically disposed at predetermined positions of both elongate edges thereon to securely combine both upper and lower slat pieces and form a retaining space thereby for holding a support member therein respectively; whereby, via the fixing portions thereof, the slat body obtained thereby can not only provide versatile stylistic change to boost the visual effect thereof, but also refrain from the problem of furry edges in production to achieve a neat and beautiful look in display thereof.

Please refer to FIG. 1. A conventional blind slat structure comprises a slat body 10 made of textile materials that is integrally woven into shape with a retaining space 11 formed at each elongate edge thereon for holding a support member 12 therein.

However, the conventional blind slat structure above contains some disadvantages. Most of all, the slat body 10 is integrally made without any fixing portions disposed thereon for connecting and decorating purposes, which can increase the defective rate of the conventional blind slat and result in uneasily trimmed furry edges A in the production thereof to destroy the look of the blind slat in display.

### SUMMARY OF THE PRESENT INVENTION

It is, therefore, the primary purpose of the present invention to provide a blind slat structure, including a slat body made up of an upper slat piece and a matching lower slat piece that are mutually overlapped with fixing portions symmetrically disposed at predetermined positions of both elongate edges thereon to securely combine both upper and lower slat pieces into one slat body thereby, efficiently reducing the defective rate of the blind slats in production thereof.

It is, therefore, the second purpose of the present invention to provide a blind slat structure wherein, via the fixing portions thereof, the slat body obtained thereby can not only provide versatile stylistic change to boost the visual effect thereof, but also refrain from the problem of furry edges in production to achieve a neat and beautiful look of the blind slat in display thereof.

### BRIEF DESCRIPTION OF THE DRAWINGS

FIG. 1 is an assembled perspective view of a conventional blind slat structure.

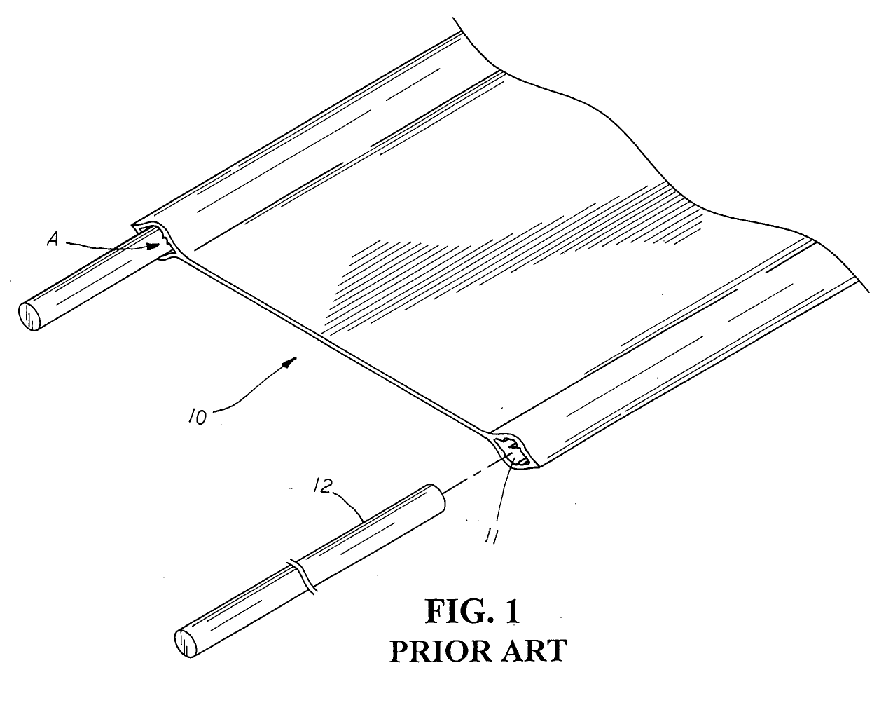

FIG. 2 is an exploded perspective view of the present invention.

FIG. 3 is an assembled perspective view of the present invention.

FIG. 4 is an assembled perspective view of another embodiment of the present invention.

FIG. 5 is an assembled perspective view of a third embodiment of the present invention.

### DETAILED DESCRIPTION OF THE PREFERRED EMBODIMENTS

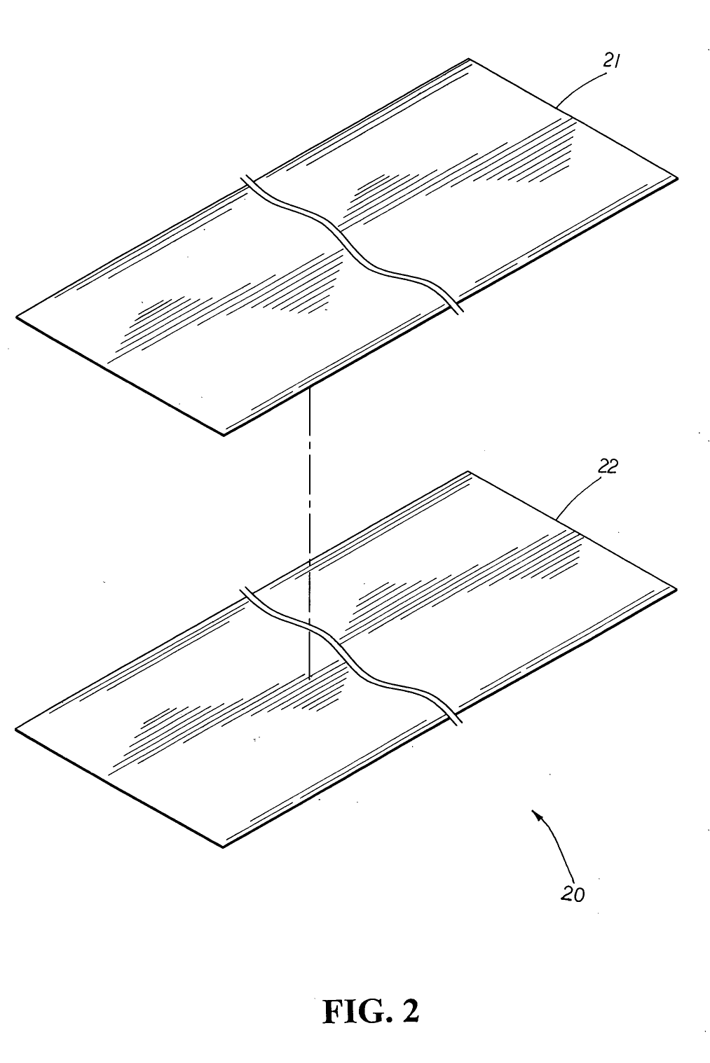

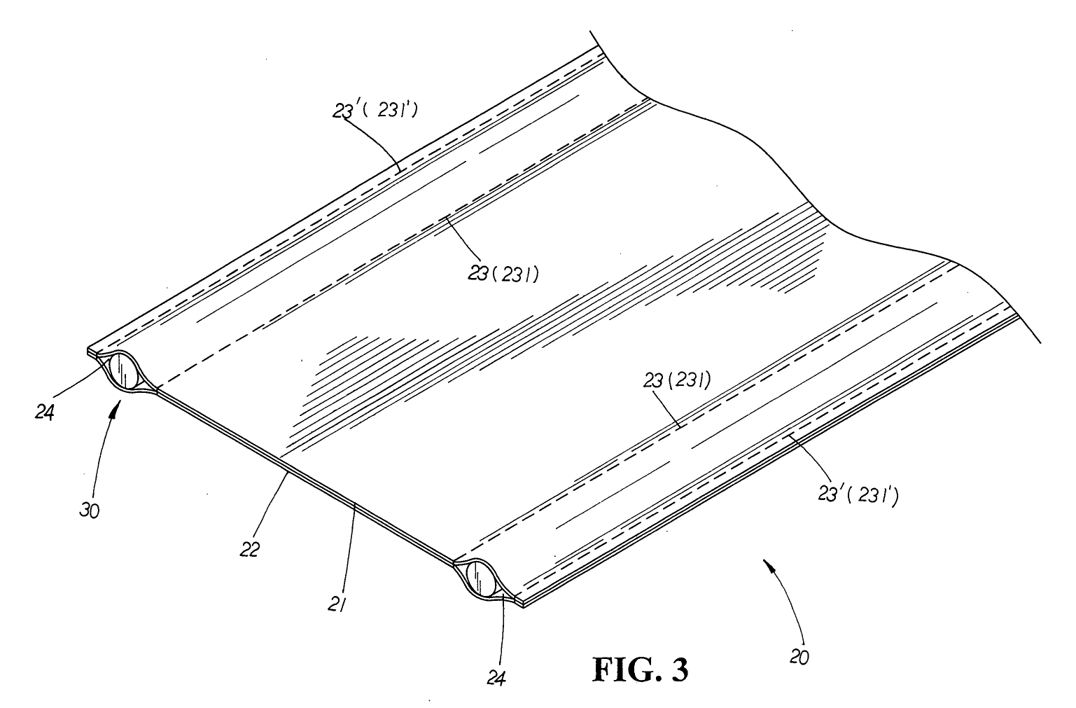

Please refer to FIGS. 2 to 3 inclusive. The present invention is related to a blind slat structure, including a slat body 20 made up of a set of upper and lower slat pieces 21, 22 of an identical width that, preferably molded by plastic materials, compound materials, glass fibers, and textile materials, etc., are mutually overlaid with one precisely superimposed on top of the other thereof. At predetermined positions of both elongate edges of the overlaid upper and lower slat pieces 21, 22 thereof are respectively disposed a pair of symmetrically parallel and equally spaced inner and outer fixing portions 23, 23′ like inner and outer seam lines 231, 231′ to securely combine both upper and lower slat pieces 21, 22 thereby and form a retaining space 24 defined there-between for holding a support member 30 made of plastic materials, wood, compound materials or glass fibers, etc. therein. Therefore, via the inner and outer fixing portions 23, 23′ thereof, the slat body 20 can not only achieve versatile stylistic change to boost the visual effect thereof, but also refrain from the problem of furry edges in production to achieve a neat and beautiful look in display thereof.

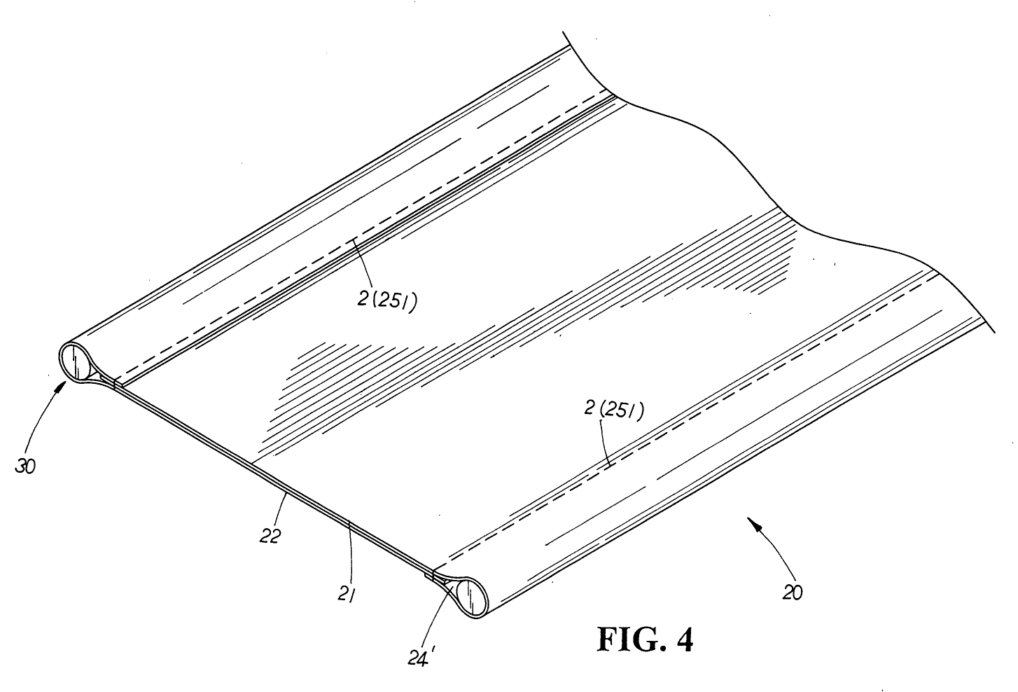

Please refer to FIG. 4 showing another embodiment of the present invention. The slat body 20 of the present invention can also be made up of a set of upper and lower slat pieces 21, 22 of an identical width wherein the upper and lower slat pieces 21, 22 are properly overlapped in a manner with each having a protruding section alternatively extending outwards at one elongate edge of the overlapped upper and lower slat pieces 21, 22 thereof to be respectively bent up or down before folded backwards to be attached to the overlapped upper and lower slat pieces 21, 22 thereof via a single fixing portion 25 like a seam line 251 and form a retaining space 24′ therein for holding the support member 30 thereby.

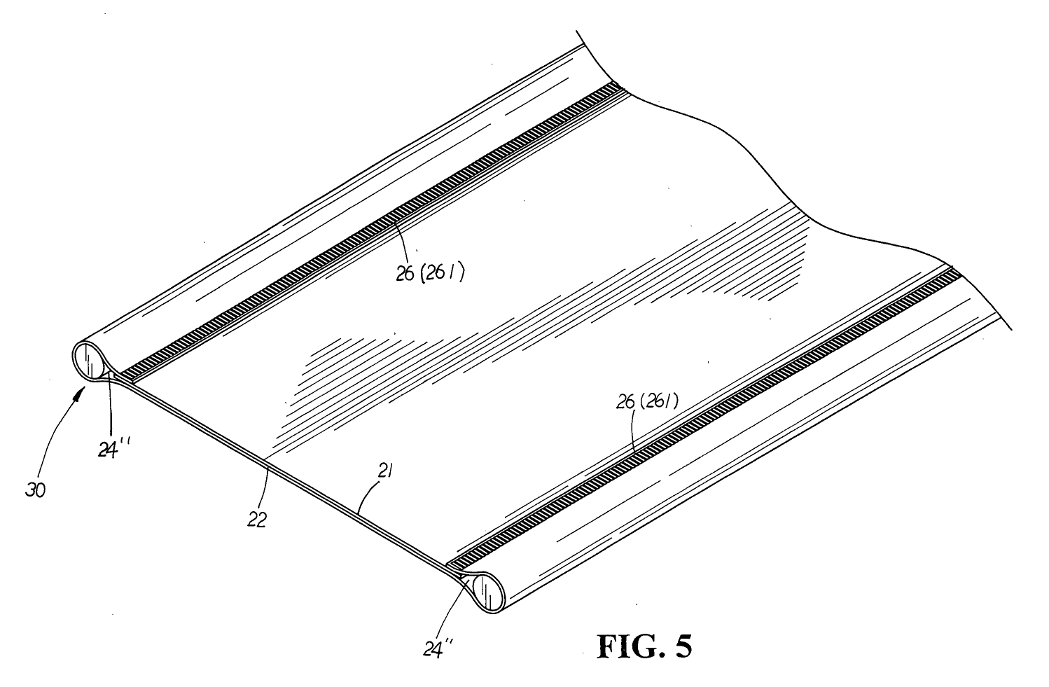

Please refer to FIG. 5 showing a third embodiment of the present invention. The slat body 20 of the present invention can also be made up of a set of upper and lower slat pieces 21, 22 of a different width wherein the narrow slat piece like the upper slat piece 21 is superimposed in the middle of the wide lower slat piece 22, and the protruding sections of the lower slat piece 22 extending outside both elongate edges of the upper slat piece 21 are respectively bent upwards before folded backwards and securely combined with both elongate edges of the upper slat piece 21 respectively via a single fixing portion 26 like an ultrasonic thermo welding line 261 to form a retaining space 24″ thereby for holding the support member 30 therein.

In addition, the inner and outer fixing portions 23, 23′, and the fixing portions 25, 26 of the slat body 20 can be mad of seam lines, 231, 231′, 251, ultrasonic thermo welding lines 261, or adhesive agent (non-illustrated in the diagrams) for the purpose thereof.

What is claimed is:

1. A blind slat structure, including a slat made up of an upper slat piece and a matching lower slat piece that are mutually overlapped with fixing portions disposed at predetermined positions of both elongate edges thereon to securely combine both upper and lower slat pieces thereby and form a retaining space at each elongate edge of the combined upper/lower slat pieces respectively for holding a support member therein; therefore, via the fixing portions thereof, the blind slat obtained thereby can not only provide versatile stylistic change to boost the visual effect thereof, but also refrain from the problem of furry edges in production to achieve a neat and beautiful look in display thereof.

2. The blind slat structure as claimed in claim 1 wherein the upper and lower slat pieces of the slat body thereof can be made of an identical width.

3. The blind slat structure as claimed in claim 1 wherein the upper and lower slat pieces of the slat body thereof can also be made of a different width with one narrow and the other wide thereof.

4. The blind slat structure as claimed in claim 1 wherein the upper and lower slat pieces of the slat body thereof can be made of plastic materials, compound materials, glass fibers, and textile materials, etc.

5. The blind slat structure as claimed in claim 1 wherein the fixing portion disposed at each elongate edge of the combined upper and lower slat pieces thereof can be made up of a pair of parallel and equally spaced inner and outer fixing portions.

6. The blind slat structure as claimed in claim 1 wherein the fixing portions of the slat body can be made of seam lines, ultrasonic thermo welding lines, and adhesive agent for the purpose thereof.

7. The blind slat structure as claimed in claim 2 wherein the upper and lower slat pieces of the blind body are mutually overlaid with one precisely superimposed on top of the other and securely combined via the fixing portions thereof with a retaining space formed at each elongate edge thereof for holding the support member therein.

8. The blind slat structure as claimed in claim 2 wherein the upper and lower slat pieces of the blind body can also be properly overlapped with each having a protruding section alternatively extending outwards at one elongate edge thereof to be respectively bent up or down before folded backwards to be attached to the overlapped upper and lower slat pieces respectively via the fixing portions thereof with a retaining space formed thereby for holding the support member therein.

9. The blind slat structure as claimed in claim 3 wherein the upper and lower slat pieces of a different width can have the narrow upper slat piece superimposed in the middle of the wide lower slat piece, and the protruding sections of the lower slat piece extending outside both elongate edges of the upper slat piece are properly bent and folded backwards to be respectively combined with each elongate edge of the upper slat pieces thereof via the fixing portion with a retaining space formed thereby for holding the support member therein.
